(19) United States
(12) Patent Application Publication
(10) Pub. No.: US 2010/0290374 A1
(43) Pub. Date: Nov. 18, 2010

(54) METHODS AND SYSTEMS FOR HANDOVER SCANNING IN FDD OR H-FDD NETWORKS

(75) Inventors: Tom Chin, San Diego, CA (US); Guangming Shi, San Diego, CA (US); Kuo-Chun Lee, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/776,335

(22) Filed: May 7, 2010

Related U.S. Application Data
(60) Provisional application No. 61/178,946, filed on May 16, 2009.

(51) Int. Cl. H04W 4/00; H04J 1/02

(52) U.S. Cl. 370/281; 370/331

(57) ABSTRACT

Certain embodiments of the present disclosure provide a method for efficient scanning of the neighboring base stations for handover by a mobile station operating in frequency division duplex while maintaining the communication with a serving base station.

### CLAIM OF PRIORITY

This application for patent claims the benefit of priority from U.S. Provisional Patent Application Ser. No. 61/178,946, entitled “Methods and Systems for Handover Scanning in Frequency Division Duplex (FDD) or Half Duplex FDD WIMAX Networks” and filed May 16, 2009, which is assigned to the assignee of this application and is fully incorporated herein by reference for all purposes.

### TECHNICAL FIELD

Certain embodiments of the present disclosure generally relate to wireless communication and, more particularly, to a method for scanning the neighboring base stations to find a target base station for handover by frequency division duplex (FDD) or half-duplex FDD (H-FDD) networks.

### SUMMARY

Certain embodiments of the present disclosure provide a method for wireless communications by a mobile station. The method generally includes communicating with a serving base station (BS) in a first frequency division duplex (FDD) group, scanning one or more neighboring base stations in a second FDD group to identify a target BS for handover, and performing handover to an identified target BS.

Certain embodiments of the present disclosure provide an apparatus for wireless communications by a mobile station. The apparatus generally includes logic for communicating with a serving base station (BS) in a first frequency division duplex (FDD) group, logic for scanning one or more neighboring base stations in a second FDD group to identify a target BS for handover, and logic for performing handover to an identified target BS.

Certain embodiments of the present disclosure provide an apparatus for wireless communications by a mobile station. The apparatus generally includes means for communicating with a serving base station (BS) in a first frequency division duplex (FDD) group, means for scanning one or more neighboring base stations in a second FDD group to identify a target BS for handover, and means for performing handover to an identified target BS.

Certain embodiments of the present disclosure provide a computer-program storage apparatus for wireless communication by a mobile station (MS), comprising a memory device having instructions stored thereon, the instructions being executable by one or more processors. The instructions generally include instructions for communicating with a serving base station (BS) in a first frequency division duplex (FDD) group, instructions for scanning one or more neighboring base stations in a second FDD group to identify a target BS for handover, and instructions for performing handover to an identified target BS.

### BRIEF DESCRIPTION OF THE DRAWINGS

So that the manner in which the above-recited features of the present disclosure can be understood in detail, a more particular description, briefly summarized above, may be had by reference to embodiments, some of which are illustrated in the appended drawings. It is to be noted, however, that the appended drawings illustrate only certain typical embodiments of this disclosure and are therefore not to be considered limiting of its scope, for the description may admit to other equally effective embodiments.

FIG. 1 illustrates an example wireless communication system, in accordance with certain embodiments of the present disclosure.

FIG. 2 illustrates various components that may be utilized in a wireless device in accordance with certain embodiments of the present disclosure.

FIG. 3 illustrates an example transmitter and an example receiver that may be used within a wireless communication system that utilizes orthogonal frequency-division multiplexing and orthogonal frequency division multiple access (OFDM/OFDMA) technology in accordance with certain embodiments of the present disclosure.

FIG. 4 illustrates an example frame structure in frequency division duplex (FDD) mode in the Worldwide Interoperability for Microwave Access (WiMAX) standard.

FIG. 5 illustrates example operations for an efficient scanning procedure for handover by mobile stations capable of full duplex frequency division duplex (FDD) or half-duplex FDD operation in WiMAX standard, in accordance with certain embodiments of the present disclosure.

FIG. 5A illustrates example components capable of performing the operations shown in FIG. 5.

FIGS. 6A and 6B illustrate an example of transmitting and receiving by a mobile station in one FDD group and scanning in the DL subframe of the other FDD group, in accordance with certain embodiments of the present disclosure.

FIGS. 7A and 7B illustrate tables for an Uplink FDD Mode Switch Request Extender Subheader and a Downlink FDD Mode Switch Response Extended Subheader, in accordance with certain embodiments of the present disclosure.

FIG. 8 illustrates an example procedure for a mobile station capable of H-FDD operation to operate in FDD group 2 and scan on the FDD group 1, in accordance with certain embodiments of the present disclosure.

FIG. 9 illustrates an example procedure for a mobile station capable of H-FDD operation to switch from the FDD group 1 to the FDD group 2, in accordance with certain embodiments of the present disclosure.

FIG. 10 illustrates an example procedure for a mobile station capable of FDD operation to switch to half-duplex operation in FDD group 2 during scanning and switch back to full-duplex FDD operation after completion of scanning, in accordance with certain embodiments of the present disclosure.

### DETAILED DESCRIPTION

Certain embodiments of the present disclosure provide a method for wireless communications by a mobile station communicating with a serving base station (BS) in a first frequency division duplex (FDD) group. The method generally includes scanning one or more neighboring base stations in a second FDD group to identify a target BS for handover and performing handover to an identified target BS.

In Worldwide Interoperability for Microwave Access (WiMAX), a mobile station (MS) may scan neighboring base stations of the same radio access technology (RAT) or a different RAT (e.g., CDMA, WCDMA) before starting a handover procedure. However, for an MS with a single transmit and receive chain, the MS should request for scanning intervals from the serving base station using a MOB-SCN-REQ message. The MS cannot transmit to or receive from the serving BS during the scanning intervals, which results in throughput degradation and service disruption for the mobile station.

### Exemplary Wireless Communication System

The techniques described herein may be used for various broadband wireless communication systems, including communication systems that are based on an orthogonal multiplexing scheme. Examples of such communication systems include Orthogonal Frequency Division Multiple Access (OFDMA) systems, Single-Carrier Frequency Division Multiple Access (SC-FDMA) systems, and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

One example of a communication system that uses orthogonal multiplexing scheme is a 3rd Generation Partnership Project (3GPP) Long Term Evolution (LTE) system. For downlink, LTE uses OFDM, and for uplink, LTE uses SC-FDMA. LTE also supports FDD, which may use certain embodiments of the present disclosure.

Another example of a communication system based on an orthogonal multiplexing scheme is a WiMAX system. WiMAX, which stands for the Worldwide Interoperability for Microwave Access, is a standards-based broadband wireless technology that provides high-throughput broadband connections over long distances. There are two main applications of WiMAX today: fixed WiMAX and mobile WiMAX. Fixed WiMAX applications are point-to-multipoint, enabling broadband access to homes and businesses, for example. Mobile WiMAX is based on OFDM and OFDMA and offers the full mobility of cellular networks at broadband speeds.

IEEE 802.16x is an emerging standard organization to define an air interface for fixed and mobile broadband wireless access (BWA) systems. These standards define at least four different physical layers (PHYs) and one media access control (MAC) layer. The OFDM and OFDMA physical layer of the four physical layers are the most popular in the fixed and mobile BWA areas respectively.

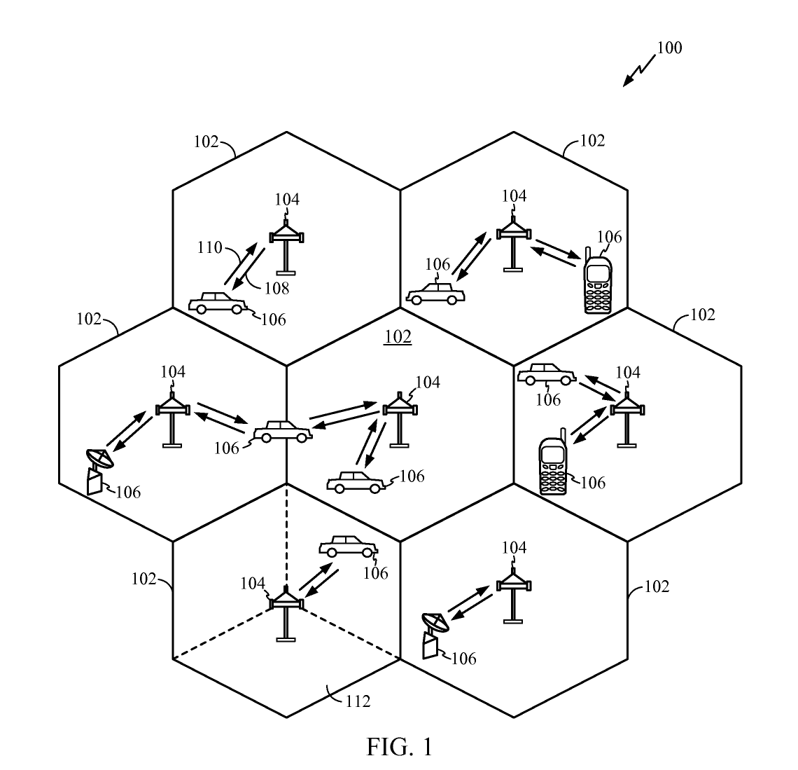

FIG. 1 illustrates an example of a wireless communication system 100. The wireless communication system 100 may be a broadband wireless communication system. The wireless communication system 100 may provide communication for a number of cells 102, each of which is serviced by a base station 104. A base station 104 may be a fixed station that communicates with user terminals 106. The base station 104 may alternatively be referred to as an access point, a Node B, or some other terminology.

FIG. 1 depicts various user terminals 106 dispersed throughout the system 100. The user terminals 106 may be fixed (i.e., stationary) or mobile. The user terminals 106 may alternatively be referred to as remote stations, access terminals, terminals, subscriber units, mobile stations, stations, user equipment, etc. The user terminals 106 may be wireless devices, such as cellular phones, personal digital assistants (PDAs), handheld devices, wireless modems, laptop computers, personal computers (PCs), etc.

A variety of algorithms and methods may be used for transmissions in the wireless communication system 100 between the base stations 104 and the user terminals 106. For example, signals may be sent and received between the base stations 104 and the user terminals 106 in accordance with OFDM/OFDMA techniques. If this is the case, the wireless communication system 100 may be referred to as an OFDM/OFDMA system.

A communication link that facilitates transmission from a base station 104 to a user terminal 106 may be referred to as a downlink 108, and a communication link that facilitates transmission from a user terminal 106 to a base station 104 may be referred to as an uplink 110. Alternatively, a downlink 108 may be referred to as a forward link or a forward channel, and an uplink 110 may be referred to as a reverse link or a reverse channel.

A cell 102 may be divided into multiple sectors 112. A sector 112 is a physical coverage area within a cell 102. Base stations 104 within a wireless communication system 100 may utilize antennas that concentrate the flow of power within a particular sector 112 of the cell 102. Such antennas may be referred to as directional antennas.

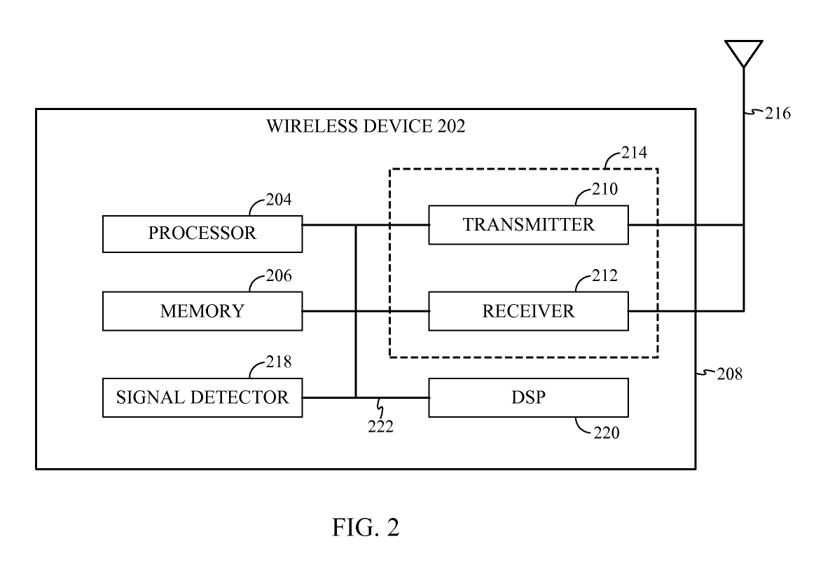

FIG. 2 illustrates various components that may be utilized in a wireless device 202. The wireless device 202 is an example of a device that may be configured to implement the various methods described herein. The wireless device 202 may be a base station 104 or a user terminal 106.

The wireless device 202 may include a processor 204 which controls operation of the wireless device 202. The processor 204 may also be referred to as a central processing unit (CPU). Memory 206, which may include both read-only memory (ROM) and random access memory (RAM), provides instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein.

The wireless device 202 may also include a housing 208 that may include a transmitter 210 and a receiver 212 to allow transmission and reception of data between the wireless device 202 and a remote location. The transmitter 210 and receiver 212 may be combined into a transceiver 214. An antenna 216 may be attached to the housing 208 and electrically coupled to the transceiver 214. The wireless device 202 may also include (not shown) multiple transmitters, multiple receivers, multiple transceivers, and/or multiple antennas.

The wireless device 202 may also include a signal detector 218 that may be used in an effort to detect and quantify the level of signals received by the transceiver 214. The signal detector 218 may detect such signals as total energy, pilot energy from pilot subcarriers or signal energy from the preamble symbol, power spectral density, and other signals. The wireless device 202 may also include a digital signal processor (DSP) 220 for use in processing signals.

The various components of the wireless device 202 may be coupled together by a bus system 222, which may include a power bus, a control signal bus, and a status signal bus in addition to a data bus.

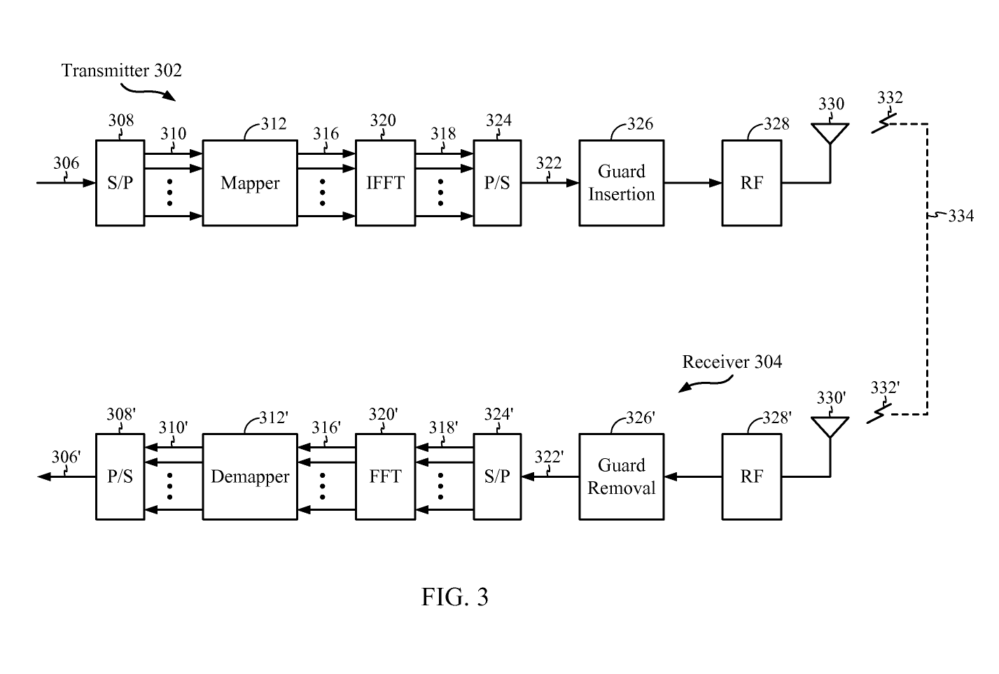

FIG. 3 illustrates an example of a transmitter 302 that may be used within a wireless communication system 100 that utilizes OFDM/OFDMA. Portions of the transmitter 302 may be implemented in the transmitter 210 of a wireless device 202. The transmitter 302 may be implemented in a base station 104 for transmitting data 306 to a user terminal 106 on a downlink 108. The transmitter 302 may also be implemented in a user terminal 106 for transmitting data 306 to a base station 104 on an uplink 110.

Data 306 to be transmitted is shown being provided as input to a serial-to-parallel (S/P) converter 308. The S/P converter 308 may split the transmission data into N parallel data streams 310.

The N parallel data streams 310 may then be provided as input to a mapper 312. The mapper 312 may map the N parallel data streams 310 onto N constellation points. The mapping may be done using some modulation constellation, such as binary phase-shift keying (BPSK), quadrature phase-shift keying (QPSK), 8 phase-shift keying (8PSK), quadrature amplitude modulation (QAM), etc. Thus, the mapper 312 may output N parallel symbol streams 316, each symbol stream 316 corresponding to one of the N orthogonal subcarriers of the inverse fast Fourier transform (IFFT) 320. These N parallel symbol streams 316 are represented in the frequency domain and may be converted into N parallel time domain sample streams 318 by an IFFT component 320.

A brief note about terminology will now be provided. N parallel modulations in the frequency domain are equal to N modulation symbols in the frequency domain, which are equal to N mapping and N-point IFFT in the frequency domain, which is equal to one (useful) OFDM symbol in the time domain, which is equal to N samples in the time domain. One OFDM symbol in the time domain, Nₛ, is equal to N_{cp} (the number of guard samples per OFDM symbol)+N (the number of useful samples per OFDM symbol).

The N parallel time domain sample streams 318 may be converted into an OFDM/OFDMA symbol stream 322 by a parallel-to-serial (P/S) converter 324. A guard insertion component 326 may insert a guard interval between successive OFDM/OFDMA symbols in the OFDM/OFDMA symbol stream 322. The output of the guard insertion component 326 may then be upconverted to a desired transmit frequency band by a radio frequency (RF) front end 328. An antenna 330 may then transmit the resulting signal 332.

FIG. 3 also illustrates an example of a receiver 304 that may be used within a wireless communication system 100 that utilizes OFDM/OFDMA. Portions of the receiver 304 may be implemented in the receiver 212 of a wireless device 202. The receiver 304 may be implemented in a user terminal 106 for receiving data 306 from a base station 104 on a downlink 108. The receiver 304 may also be implemented in a base station 104 for receiving data 306 from a user terminal 106 on an uplink 110.

The transmitted signal 332 is shown traveling over a wireless channel 334. When a signal 332′ is received by an antenna 330′, the received signal 332′ may be downconverted to a baseband signal by an RF front end 328′. A guard removal component 326′ may then remove the guard interval that was inserted between OFDM/OFDMA symbols by the guard insertion component 326.

The output of the guard removal component 326′ may be provided to an S/P converter 324′. The S/P converter 324′ may divide the OFDM/OFDMA symbol stream 322′ into the N parallel time-domain symbol streams 318′, each of which corresponds to one of the N orthogonal subcarriers. A fast Fourier transform (FFT) component 320′ may convert the N parallel time-domain symbol streams 318′ into the frequency domain and output N parallel frequency-domain symbol streams 316′.

A demapper 312′ may perform the inverse of the symbol mapping operation that was performed by the mapper 312, thereby outputting N parallel data streams 310′. A P/S converter 308′ may combine the N parallel data streams 310′ into a single data stream 306′. Ideally, this data stream 306′ corresponds to the data 306 that was provided as input to the transmitter 302.

### Exemplary Handover Scanning in FDD or H-FDD Networks

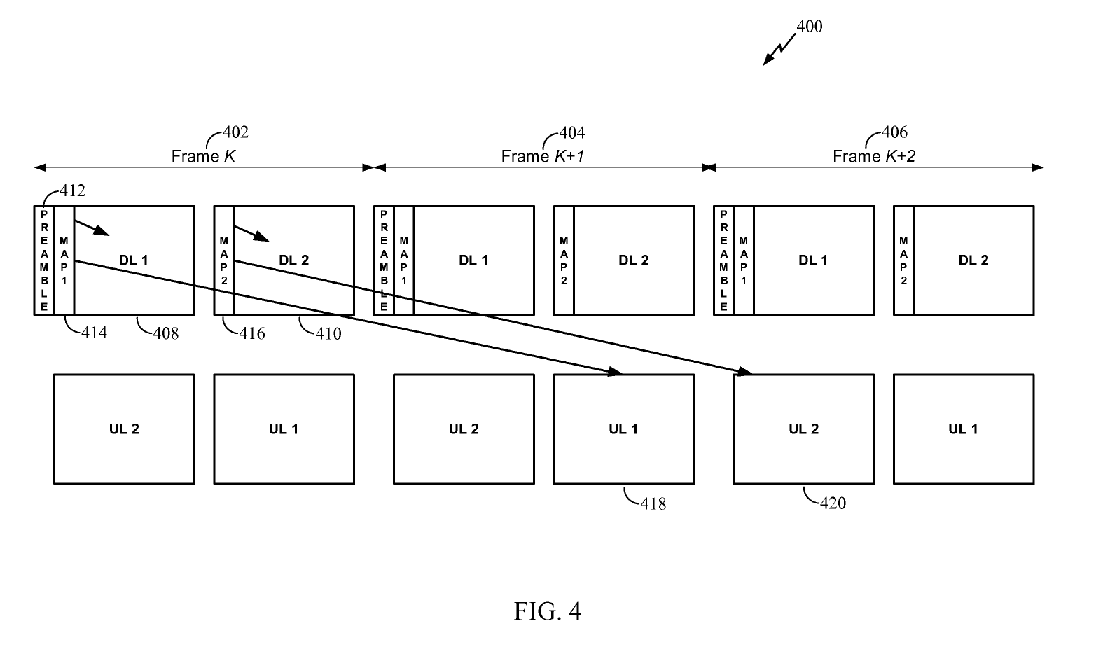

The WiMAX standard provides FDD (Frequency Division Duplex) in addition to the TDD (Time Division Duplex) operation of mobile stations. FIG. 4 illustrates a frame structure for FDD operation. The downlink (DL) and uplink (UL) may operate on different frequencies. Each DL part of the frame is divided into two groups, in which group 1 leads group 2. Each UL part of the frame is divided into two groups, in which group 2 leads group 1. The first DL subframe includes preamble 412, FCH1 (Frame Control Header 1), DL MAP1, UL MAP2, DCD (Downlink Channel Descriptor) and UCD (Uplink Channel Descriptor) messages. The second DL subframe includes FCH2 (Frame Control Header 2), DL MAP2, UL MAP2, DCD and UCD messages.

Each group of resources may be allocated independently. The DL MAP1 414 of frame K 402 allocates the data bursts of the first DL subframe 408 of frame K 402 and UL MAP1 of frame K 402 allocates the data bursts of the second UL subframe 418 of frame K+1 404. The DL MAP2 416 of frame K 402 allocates the data bursts of the second DL subframe 410 of frame K and UL MAP2 of frame K allocates the data bursts of the first UL subframe 420 of frame K+2 406. DCD and UCD of these two groups are the same.

A mobile station (MS) may have one of the two possible capabilities: H-FDD (Half-Duplex Frequency Division Duplex) or FDD (Full-Duplex Frequency Division Duplex). In the FDD mode, an MS can transmit and receive in both of the two groups. In H-FDD mode, an MS can transmit and receive in only one of two H-FDD groups. The base station (BS) shall always operate in FDD.

In the WiMAX standard, a mobile station may scan neighboring base stations of the same RAT or a different RAT (e.g., CDMA, WCDMA) before starting a handover procedure. However, for an MS with a single transmit and receive chain, the MS should request for scanning intervals from the serving base station using a MOB-SCN-REQ message. The MS cannot transmit to or receive from the serving BS during the scanning intervals, which results in throughput degradation and service disruption for the mobile station.

The current disclosure proposes a technique for the mobile station in an FDD system, in which scanning for intra-RAT or inter-RAT handover may be performed with minimal service disruption.

For certain embodiments of the present disclosure, a mobile station may use one DL subframe to perform scanning and the other DL subframe to communicate with the serving base station. In particular, a mobile station capable of full duplex operation may need to switch down to a H-FDD mode and therefore it can still transmit and receive in one H-FDD group and scan in the DL subframe of other H-FDD group. When scanning completes, the MS can resume the regular FDD mode.

For certain embodiments of the present disclosure, an MS capable of performing half-duplex operation, which does not need to switch to the other H-FDD group for scanning, can always use the other unused DL subframe for scanning.

For another embodiment of the present disclosure, an H-FDD MS can also request for switching to the other H-FDD to facilitate scanning. This is especially useful for a time synchronous WiMAX system in which the preamble of a neighbor BS is transmitted approximately the same time as the preamble of the serving BS. Therefore, MS in H-FDD group 1 should switch to H-FDD group 2 to transmit and receive while receiving preamble signal in the first DL subframe of the neighboring base stations. At the end of scanning, MS can request to switch back to H-FDD group 1 if needed.

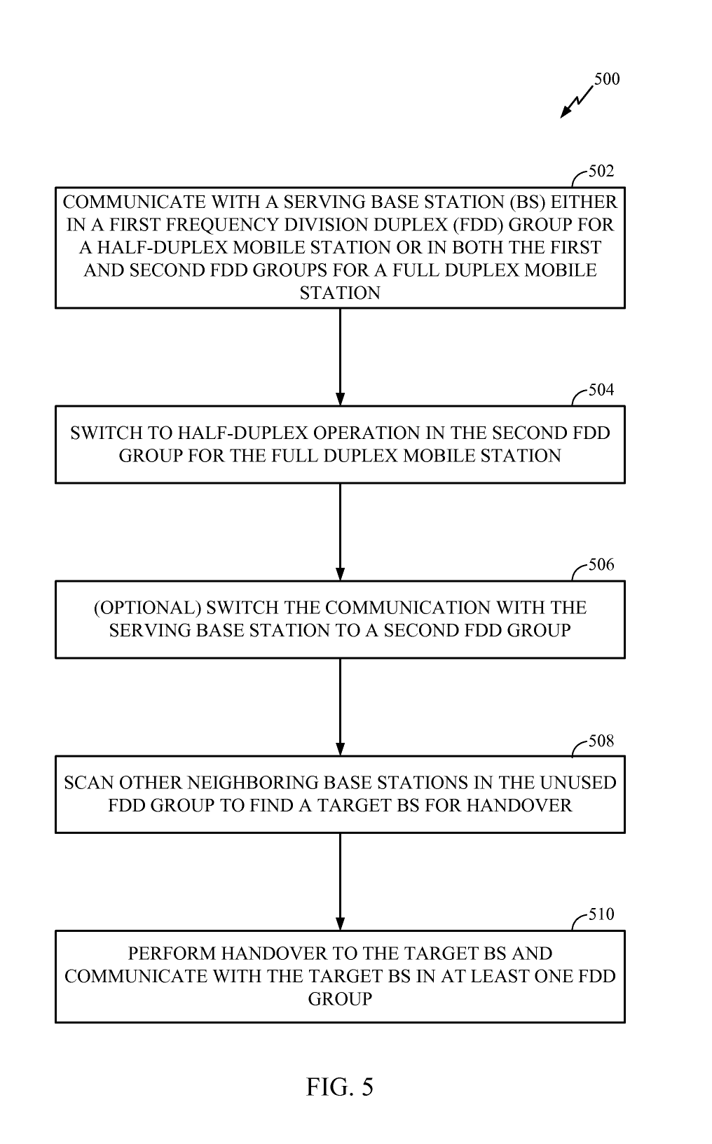

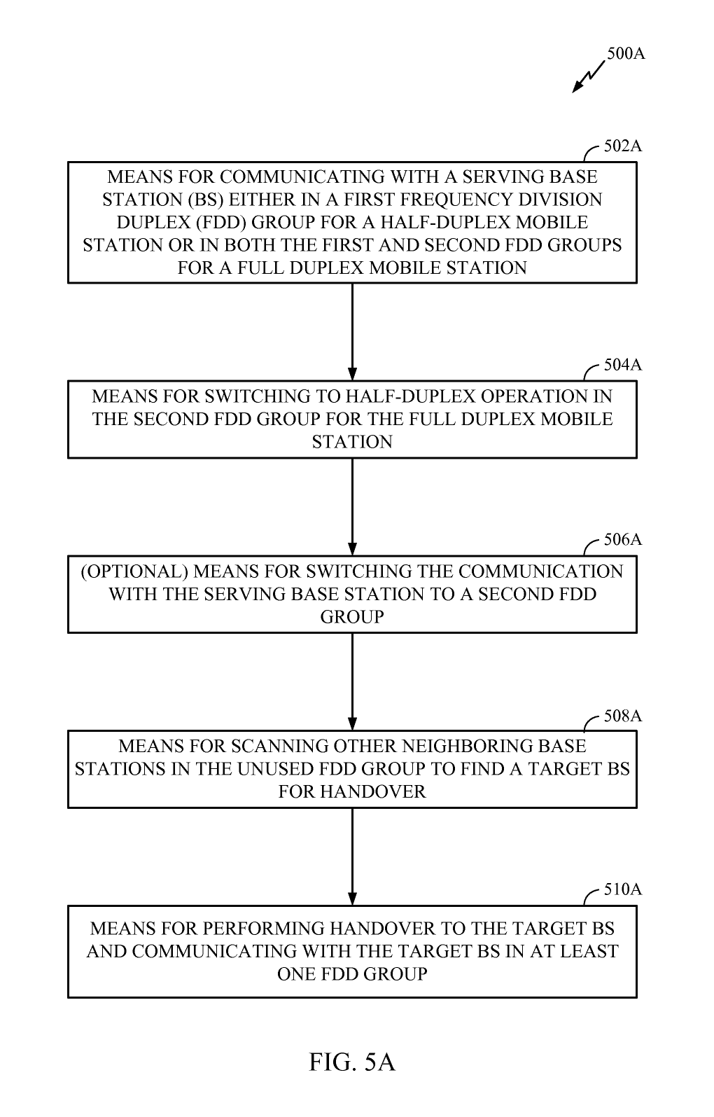

FIG. 5 illustrates example operations for an efficient scanning procedure for handover by mobile stations capable of full duplex frequency division duplex (FDD) or half-duplex FDD operation in WiMAX standard, in accordance with certain embodiments of the present disclosure. At 502, a mobile station communicates with a serving base station (BS) either in a first frequency division duplex (FDD) group for a mobile station capable of half-duplex operation or in both the first and second FDD groups for a full duplex mobile station. At 504, if the mobile station is operating in full-duplex mode, the mobile station switches to half-duplex operation in the second FDD group. At 506, the mobile station optionally switches to a second FDD group for the communication with the serving base station. At 508, the mobile station scans other neighboring base stations in the unused FDD group to find a target BS for handover. At 510, the mobile station performs handover to the target BS and communicates with the target BS in at least one FDD group.

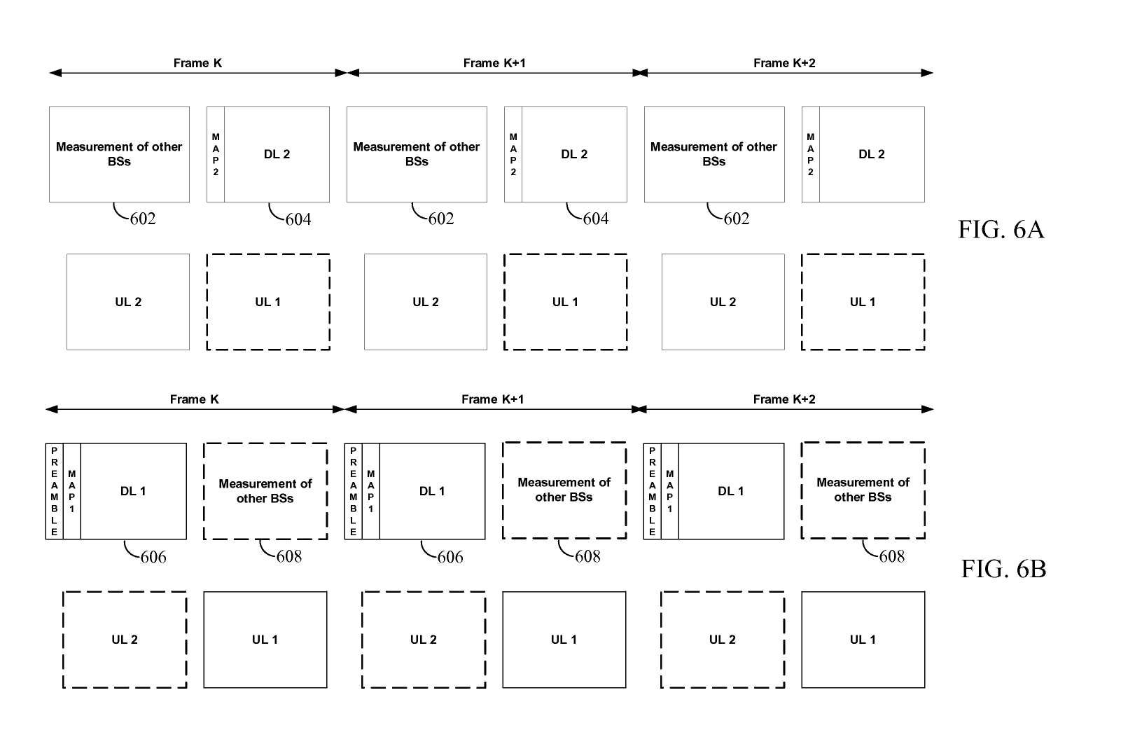

FIGS. 6A and 6B illustrate an example of transmitting and receiving by a mobile station in one FDD group and scanning in the DL subframe of the other FDD group, in accordance with certain embodiments of the present disclosure. In FIG. 6A a mobile station communicates with the serving base station in H-FDD group 2 604 and scans other neighboring base stations on the first DL subframe 602. In FIG. 6B, a mobile station communicates with the serving base station in H-FDD group 1 606 and scans other base stations on the second DL subframe 608.

For certain embodiments of the present disclosure, a mobile station may perform the following tasks in the UL subframe utilized for scanning: 1) Tune its RF chain to other frequencies if needed. 2) Detect the presence of other base stations in the same RAT or other RATs. 3) Acquire preamble or pilot signal. 4) Synchronize to a frame and a frequency. 5) Evaluate signal strength of other base stations (e.g., RSSI or CINR). For WiMAX, an MS can also receive BS ID of the DL-MAP message, and DCD, UCD, NBR-ADV (Neighbor Advertisement) overhead messages. 6) Evaluate if the MS can handover to other base stations and determine a target BS.

In order to enable the mobile station to switch the FDD group and scan, the current disclosure proposes two new Extended Subheader types, such as UL FDD Mode Switch Request Extended Subheader and DL FDD Mode Switch Response Extended Subheader.

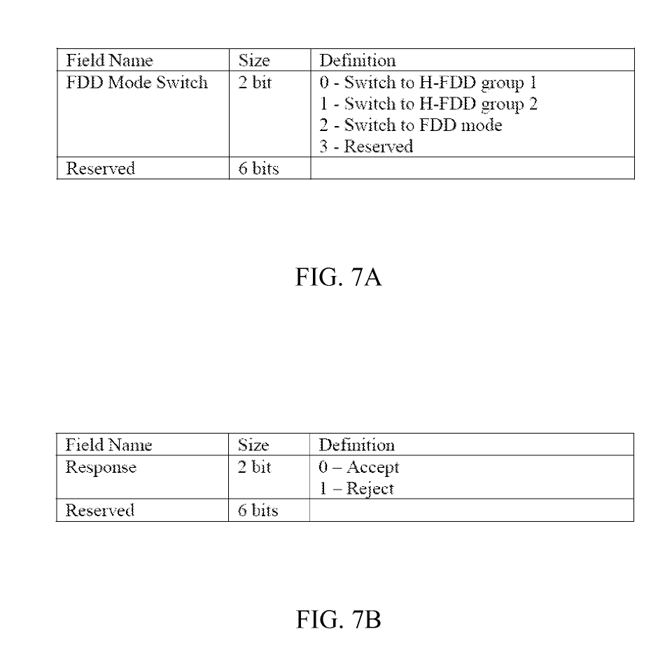

FIGS. 7A and 7B illustrate tables for an Uplink FDD Mode Switch Request Extender Subheader and a Downlink FDD Mode Switch Response Extended Subheader, in accordance with certain embodiments of the present disclosure.

When a BS receives a request for switching the FDD group from an MS, the BS may confirm or reject the request by returning ‘Accept’ or ‘Reject’ in the extended subheader. The rejection could be due to overload conditions.

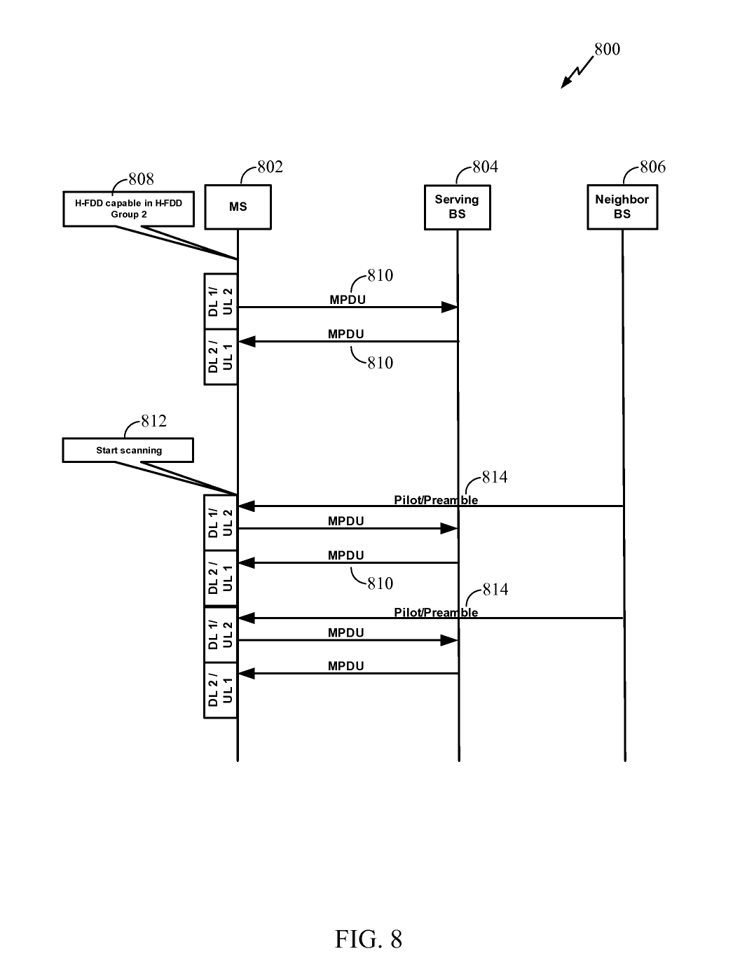

FIG. 8 illustrates an example procedure for a mobile station 802 capable of H-FDD operation to operate in FDD group 2 808 and scan on the FDD group 1, in accordance with certain embodiments of the present disclosure. The mobile station sends and receives an MPDU (MAC Packet Data Unit) 810 to the serving base station 804 in FDD group 2. When the mobile station starts scanning 812, it receives a pilot/preamble 814 from a neighbor BS 806 in the first DL subframe. In addition, the mobile station communicates with the serving BS 804 in FDD group 2.

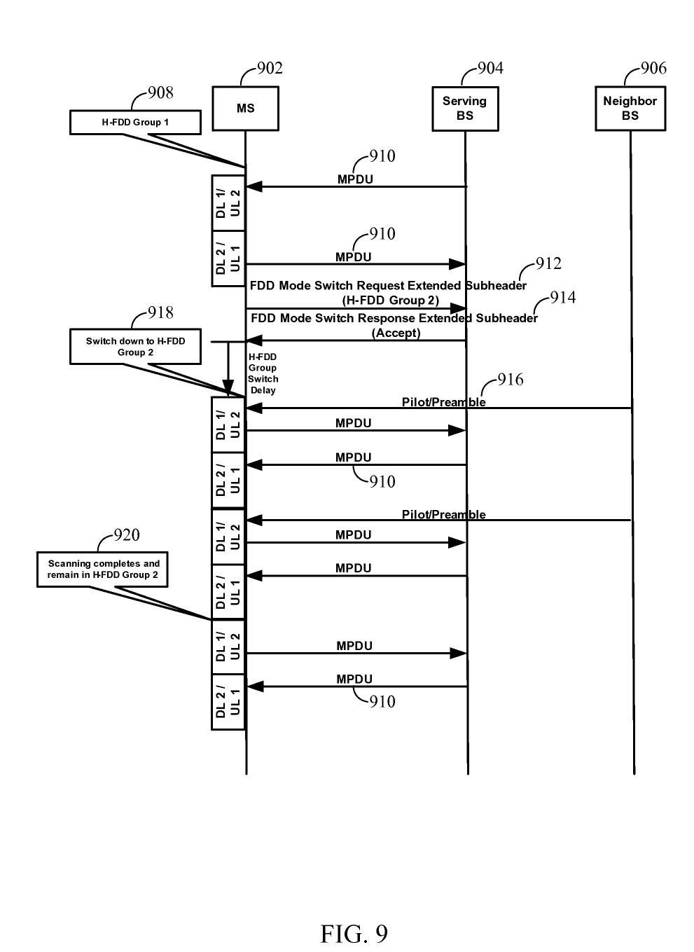

FIG. 9 illustrates an example procedure for a mobile station capable of H-FDD operation to switch from the FDD group 1 to the FDD group 2, in accordance with certain embodiments of the present disclosure. The MS 902 operates 908 in FDD group 1 to send and receive MPDU messages 910. The MS sends a request for changing the FDD group to the base station through an FDD Mode Switch Response Extended Subheader message 912 and receives the acceptance from the serving base station through FDD Mode Switch Response Extended Subheader message 914.

The MS switches 908 from H-FDD group 1 to H-FDD group 2 918 after H-FDD Group Switch Delay frames. The H-FDD Group Switch Delay may be specified in the UCD message. The MS receives pilot/preamble 916 from the neighbor base station in DL subframe 1 and communicates with the serving base station in FDD group 2. The MS remains 920 in H-FDD group 2 after scanning completes.

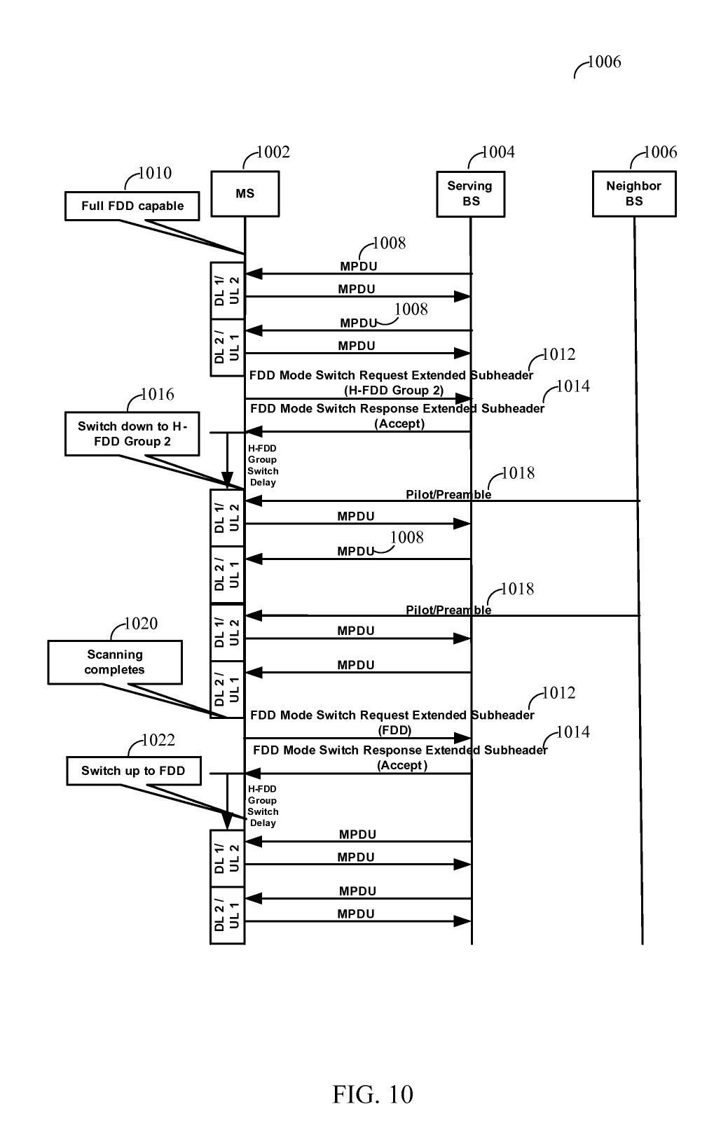

FIG. 10 illustrates an example procedure for a mobile station capable of FDD operation to switch to half-duplex operation in FDD group 2 during scanning and switch back to full-duplex FDD operation after completion of scanning, in accordance with certain embodiments of the present disclosure. The MS 1002 operates 1010 in full duplex mode in both FDD groups to send and receive MPDU messages 1008. The MS sends a request for changing its mode of operation to half-duplex in group 2 to the base station through an FDD Mode Switch Response Extended Subheader message 1012 and receives the acceptance from the serving base station through FDD Mode Switch Response Extended Subheader message 1014.

After receiving the acceptance, the MS switches 1016 from full duplex mode to half-duplex mode of operation in H-FDD group 2 1016 after H-FDD Group Switch Delay frames. The H-FDD Group Switch Delay may be specified in the UCD message.

The MS receives pilot/preamble 1018 from the neighbor base station in DL subframe 1 and communicates with the serving base station in FDD group 2 through MPDU 1008 messages. When scanning completes 1020, the MS sends a request for changing its mode of operation to full-duplex to the base station through an FDD Mode Switch Response Extended Subheader message 1012 and receives the acceptance from the serving base station through FDD Mode Switch Response Extended Subheader message 1014. After receiving the response from serving BS, MS switches to full duplex operation 1022 after H-FDD Group Switch Delay frames.

The present disclosure proposed a technique for efficiently scanning the neighbor base stations while maintaining the communication with the serving base station. The proposed technique avoids service disruption during handover scanning and improves system throughput.

The various operations of methods described above may be performed by various hardware and/or software component(s) and/or module(s) corresponding to means-plus-function blocks illustrated in the Figures. Generally, where there are methods illustrated in Figures having corresponding counterpart means-plus-function Figures, the operation blocks correspond to means-plus-function blocks with similar numbering. For example, blocks 502-510 illustrated in FIG. 5 correspond to means-plus-function blocks 502A-510A illustrated in FIG. 5A.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

Information and signals may be represented using any of a variety of different technologies and techniques. For example, data, instructions, commands, information, signals and the like that may be referenced throughout the above description may be represented by voltages, currents, electromagnetic waves, magnetic fields or particles, optical fields or particles or any combination thereof.

The various illustrative logic blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device, discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core or any other such configuration.

The steps of a method or algorithm described in connection with the present disclosure may be embodied directly in hardware, in a software module executed by a processor or in a combination of the two. A software module may reside in any form of storage medium that is known in the art. Some examples of storage media that may be used include RAM memory, flash memory, ROM memory, EPROM memory, EEPROM memory, registers, a hard disk, a removable disk, a CD-ROM and so forth. A software module may comprise a single instruction, or many instructions, and may be distributed over several different code segments, among different programs and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in software, the functions may be stored as one or more instructions on one or more computer-readable media or memory devices. A storage medium or memory device may be any available media that can be accessed by a computer or one or more processors, and may be on-chip or off-chip storage. By way of example, and not limitation, such computer-readable media or storage devices can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein, such as those illustrated in the Figures, can be downloaded and/or otherwise obtained by a mobile device and/or base station as applicable. For example, such a device can be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a mobile device and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for wireless communications by a mobile station, comprising:
communicating with a serving base station (BS) in a first frequency division duplex (FDD) group;
scanning one or more neighboring base stations in a second FDD group to identify a target BS for handover; and
performing handover to an identified target BS.

2. The method of claim 1, wherein the mobile station is capable of half-duplex FDD communications.

3. The method of claim 1, wherein the mobile station is capable of full-duplex FDD communications.

4. The method of claim 1, comprising:
switching to the second FDD group and communicating with the serving BS in the second FDD group; and
scanning other neighboring base stations in the first FDD group to find a target BS for handover.

5. The method of claim 1, comprising:
switching to the first FDD group from the second FDD group and communicating with the target BS in the first FDD group.

6. The method of claim 1, comprising:
communicating with the target BS in the second FDD group.

7. The method of claim 1, comprising:
switching to half-duplex operation from full-duplex operation and communicating with the serving BS in the first FDD group.

8. The method of claim 1, wherein communicating with the target BS comprises:
switching to full-duplex operation from half-duplex operation and communicating with the target BS in both the first and second FDD groups.

9. An apparatus for wireless communications by a mobile station, comprising:
logic for communicating with a serving base station (BS) in a first frequency division duplex (FDD) group;
logic for scanning one or more neighboring base stations in a second FDD group to identify a target BS for handover; and
logic for performing handover to an identified target BS.

10. The apparatus of claim 9, wherein the mobile station is capable of half-duplex FDD communications.

11. The apparatus of claim 9, wherein the mobile station is capable of full-duplex FDD communications.

12. The apparatus of claim 9, comprising:
logic for switching to the second FDD group and communicating with the serving BS in the second FDD group; and
logic for scanning other neighboring base stations in the first FDD group to find a target BS for handover.

13. The apparatus of claim 9, comprising:
logic for switching to the first FDD group from the second FDD group and communicating with the target BS in the first FDD group.

14. The apparatus of claim 9, comprising:
logic for communicating with the target BS in the second FDD group.

15. The apparatus of claim 9, comprising:
logic for switching to half-duplex operation from full-duplex operation and communicating with the serving BS in the first FDD group.

16. The apparatus of claim 9, wherein communicating with the target BS comprises:
logic for switching to full-duplex operation from half-duplex operation and communicating with the target BS in both the first and second FDD groups.

17. An apparatus for wireless communications by a mobile station, comprising:
means for communicating with a serving base station (BS) in a first frequency division duplex (FDD) group;
means for scanning one or more neighboring base stations in a second FDD group to identify a target BS for handover; and
means for performing handover to an identified target BS.

18. The apparatus of claim 17, wherein the mobile station is capable of half-duplex FDD communications.

19. The apparatus of claim 17, wherein the mobile station is capable of full-duplex FDD communications.

20. The apparatus of claim 17, comprising:
means for switching to the second FDD group and communicating with the serving BS in the second FDD group; and
means for scanning other neighboring base stations in the first FDD group to find a target BS for handover.

21. The apparatus of claim 17, comprising:
means for switching to the first FDD group from the second FDD group and communicating with the target BS in the first FDD group.

22. The apparatus of claim 17, comprising:
means for communicating with the target BS in the second FDD group.

23. The apparatus of claim 17, comprising:
means for switching to half-duplex operation from full-duplex operation and communicating with the serving BS in the first FDD group.

24. The apparatus of claim 17, wherein communicating with the target BS comprises:
means for switching to full-duplex operation from half-duplex operation and communicating with the target BS in both the first and second FDD groups.

25. A computer-program storage apparatus for wireless communication by a mobile station (MS), comprising a memory device having instructions stored thereon, the instructions being executable by one or more processors and the instructions comprising, comprising:
instructions for communicating with a serving base station (BS) in a first frequency division duplex (FDD) group;
instructions for scanning one or more neighboring base stations in a second FDD group to identify a target BS for handover; and
instructions for performing handover to an identified target BS.

26. The computer-program storage apparatus of claim 25, wherein the mobile station is capable of half-duplex FDD communications.

27. The computer-program storage apparatus of claim 25, wherein the mobile station is capable of full-duplex FDD communications.

28. The computer-program storage apparatus of claim 25, wherein the instructions further comprise:
instructions for switching to the second FDD group and communicating with the serving BS in the second FDD group; and
instructions for scanning other neighboring base stations in the first FDD group to find a target BS for handover.

29. The computer-program storage apparatus of claim 25, wherein the instructions further comprise:
instructions for switching to the first FDD group from the second FDD group and communicating with the target BS in the first FDD group.

30. The computer-program storage apparatus of claim 25, wherein the instructions further comprise:
instructions for communicating with the target BS in the second FDD group.

31. The computer-program storage apparatus of claim 25, wherein the instructions further comprise:
instructions for switching to half-duplex operation from full-duplex operation and communicating with the serving BS in the first FDD group.

32. The computer-program storage apparatus of claim 25, wherein the instructions for communicating with the target BS comprise:
instructions for switching to full-duplex operation from half-duplex operation and communicating with the target BS in both the first and second FDD groups.
